(19) United States
(12) Patent Application Publication
(10) Pub. No.: US 2013/0113904 A1
(43) Pub. Date: May 9, 2013

(54) System and Method for Multiple Viewing-Window Display of Computed Spectral Images

(71) Applicant: Kang-Huai Wang, Saratoga, CA (US)

(72) Inventor: Kang-Huai Wang, Saratoga, CA (US)

(73) Assignee: CAPSO VISION, INC., Saratoga, CA (US)

(21) Appl. No.: 13/291,348

(22) Filed: Nov. 8, 2011

(51) Int. Cl. H04N 7/18

(52) U.S. Cl. 348/65; 348/E07.085

(57) ABSTRACT

Method and Systems are provided for presenting in-vivo image data. In order to increase the efficiency of viewing computed spectral sequences, the computed spectral sequences are generated according to a set of spectral patterns and the multiple computed spectral sequences are displayed using multiple display windows on one or more display devices. Various aspects of user interface related to presentation of concurrent presentation of computed spectral sequences are addressed. Graphic representation corresponding to the spectral pattern associated with said each computed spectral sequence can be displayed. Furthermore, user interface to select a set of spectral patterns from a plurality of sets of spectral patterns can be provided. The method may further comprise providing user interface to modify one or more parameters of the spectral pattern associated with a selected spectral color image.

### FIELD OF THE INVENTION

The present invention relates to diagnostic imaging inside the human body. In particular, the present invention relates to displaying chromoendoscopy sequences concurrently using multiple viewing windows.

### BACKGROUND

In recent years, virtual chromoendoscopy has been found useful for enhancing microvascular contrast and facilitating minute resolution of superficial patterns and color differences. Virtual chromoendoscopy can be achieved via Narrow Band Imaging (NBI) or computed virtual chromoendoscopy. In conventional endoscopy, a light source is used with a filter disk consisting of red (R), green (G) and blue (B) filters to provide RGB illuminations to irradiate the mucosa sequentially via a light guide made of optical fiber bundle. A monochromatic image sensor may be used to capture the light reflected from the tissue. The RGB filters for conventional endoscopy have relatively wide spectral bandwidth and the spectral responses of these filters are usually overlapped. For NBI, a larger number of filters are used and each filter usually has much narrower spectral bandwidth, such as 20 nm or 30 nm. However, filters with various spectral bandwidths are also practiced in the field. Often three narrow band images are used to drive a display device having RGB channels. Since the number of filters is substantially increased, it will take much long time to irradiate the mucosa sequentially through all filters. Another virtual chromoendoscopy is Computed Virtual Chromoendoscopy (CVC) that accepts an endoscopic image and processes it mathematically to form virtual images corresponding to a set of wavelengths. Fujinon Intelligence Color-Enhancement (FICE) system is a CVC system being used in the field. FICE uses pre-defined spectral patterns where each spectral pattern consists of three wavelengths. Accordingly, three virtual images are computed for the three wavelengths and the three virtual images are used to drive the RGB channels of a display device. The CVC technology is also applicable to in-vivo images captured using a capsule device. The capsule device may transmit captured images wirelessly to a base station. Alternatively, the capsule device may use an on-board memory device to store the captured images. The FICE system provides an interface to allow a user to switch among an original image and CVC images corresponding to a set of pre-defined spectral patterns. The user may have to try multiple spectral patterns to identify one that offers the best visibility of certain features being studies, such as anomaly. Therefore, it is desirable to develop a method and system that can efficiently present the computed virtual chromoendoscopy sequences and allow a user to view and/or modify parameters associated with the computed virtual chromoendoscopy sequences.

### BRIEF SUMMARY OF THE INVENTION

The present invention provides an effective method and system for viewing an image sequence from an in-vivo imaging device. In one embodiment according to the present invention, a method and system for presenting in-vivo image data is disclosed. The method and system comprises receiving in-vivo image data from an in-vivo imaging device; generating a plurality of computed spectral sequences based on the in-vivo image data, wherein each computed spectral sequence is derived from the in-vivo image data according to a spectral pattern; and displaying the plurality of computed spectral sequences concurrently on one or more display devices. In one embodiment according to the present invention, the spectral pattern comprises three spectral responses corresponding to three color filters. Each computed spectral color image of said each computed spectral sequence consists of three spectral images generated from each image of the in-vivo image data according to the three spectral responses.

The present invention also addresses various aspects of user interface related to presentation of concurrent presentation of computed spectral sequences. In one embodiment, the method further comprises displaying graphic representation corresponding to the spectral pattern associated with said each computed spectral sequence. The graphic representation can be related to a color derived from the spectral pattern. In another embodiment, the method further comprises providing user interface to select a set of spectral patterns from a plurality of sets of spectral patterns, wherein the set of spectral patterns is associated with the plurality of computed spectral sequences displayed on said one or more display devices. The user interface can be based on graphic user interface or text user interface. In yet another embodiment, the method further comprises providing user interface to modify one or more parameters of the spectral pattern associated with a selected spectral sequence of the plurality of computed spectral sequences displayed on said one or more display devices. The parameters of the spectral pattern may be selected from a group consisting of wavelength, bandwidth and gain associated with each of three spectral responses corresponding to three color filters.

### BRIEF DESCRIPTION OF THE DRAWINGS

FIG. 1 illustrates exemplary spectral responses of an image sensor with RGB color filter array.

FIG. 2A illustrates an example of 3×2 window configuration for concurrent sequence display using multiple windows.

FIG. 2B illustrates an example of window configuration for concurrent sequence display, where two windows in the first row and three windows in the second row.

FIG. 3 illustrates an example of text-based user interface for selecting a set of spectral patterns.

FIG. 4 illustrates an example of graphic-based user interface for selecting a set of spectral patterns.

FIG. 5A illustrates an example of multiple display windows for concurrent CVC sequence display with graphic-based user interface indicating a set of spectral patterns associated with the CVC sequences.

FIG. 5B illustrates an example of multiple display windows for concurrent CVC sequence display with alternative graphic-based user interface indicating a set of spectral patterns associated with the CVC sequences.

FIG. 5C illustrates an example of multiple display windows for concurrent CVC sequence display with graphic-based user interface for selecting a set of spectral patterns.

FIG. 5D illustrates an example of multiple display windows for concurrent CVC sequence display with alternative graphic-based user interface for selecting a set of spectral patterns.

FIG. 6 illustrates an example of graphic-based user interface with text information for selecting a set of spectral patterns.

FIGS. 7A-C illustrate an example of graphic-based user interface for modifying wavelengths of a spectral pattern.

FIG. 8 illustrates an example of multiple display windows for concurrent CVC sequence display with graphic-based user interface for selecting a set of spectral patterns and graphic-based user interface for modifying wavelengths of a spectral pattern.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Devices for imaging body cavities or passages in vivo are known in the art and include endoscopes and autonomous encapsulated cameras. Endoscopes are flexible or rigid tubes that pass into the body through an orifice or surgical opening, typically into the esophagus via the mouth or into the colon via the rectum. An image is formed at the distal end using a lens and transmitted to the proximal end, outside the body, either by a lens-relay system or by a coherent fiber-optic bundle. A conceptually similar instrument might record an image electronically at the distal end, for example using a CCD or CMOS array, and transfer the image data as an electrical signal to the proximal end through a cable. Endoscopes allow a physician control over the field of view and are well-accepted diagnostic tools.

Because of the difficulty traversing a convoluted passage, endoscopes cannot reach the majority of the small intestine and special techniques and precautions, that add cost, are required to reach the entirety of the colon. Endoscopic risks include the possible perforation of the bodily organs traversed and complications arising from anesthesia. Moreover, a trade-off must be made between patient pain during the procedure and the health risks and post-procedural down time associated with anesthesia. Endoscopies are necessarily inpatient services that involve a significant amount of time from clinicians and thus are costly.

An alternative in vivo image sensor that addresses many of these problems is capsule endoscope. A camera is housed in a swallowable capsule, along with a radio transmitter for transmitting data, primarily comprising images recorded by the digital camera, to a base-station receiver or transceiver and data recorder outside the body. The capsule may also include a radio receiver for receiving instructions or other data from a base-station transmitter. Instead of radio-frequency transmission, lower-frequency electromagnetic signals may be used. Power may be supplied inductively from an external inductor to an internal inductor within the capsule or from a battery within the capsule. In addition to transmitting captured images to a base station outside the body, an autonomous capsule camera system with on-board data storage may also be used. For example, U.S. Pat. No. 7,983,458, entitled “In Vivo Autonomous Camera with On-Board Data Storage or Digital Wireless Transmission in Regulatory Approved Band,” issued on Jul. 19, 2011 disclosed a capsule camera with on-board memory to archive the captured images. Images from endoscopy are usually viewed in real-time when endoscopy is administered. Images from capsule camera regardless of being transmitted via wireless or being stored using on-board storage, are usually uploaded to a base station equipped with display devices for healthcare professionals to view. The collection of images often are played back on the display device or devices at a certain display speed and various playback controls, such Pause, Forward, and Reverse may be offered. The collection of images is also referred to as a sequence in this disclosure.

Chromoendoscopy is a technique developed in recent years to enhance tissue characterization, differentiation, or diagnosis by applying stains or dyes at the time of endoscopy. There are several different types of stains that are used for chromoendoscopy, including absorptive, contrast, and reactive. The stain is usually sprayed onto the mucosa in a uniform mist using a spray catheter. While chromoendoscopy may help to enhance visibility of anomaly, it requires introducing staining agent(s) into human organ which may not be desirable. Furthermore, there are many problems associated with chromoendoscopy such as the difficulty in achieving a complete and uniform dye spray on the mucosa, the extra cost associated with equipment for dye spraying, and the extra time in performing the procedure. Narrow band imaging (NBI) is another endoscopic technique to enhance tissue characterization, differentiation, or diagnosis. Instead of spraying color stains onto the tissues, NBI uses different color filters to illuminate the tissues with different colors. In NBI, the light spectrum is shifted over a range of wavelengths, and wavelength-induced changes in visibility are utilized. The depth of penetration into the gastrointestinal tract mucosa depends on the light's wavelength. For example, the blue band is more responsive for superficial characteristics, the green band is for more responsive intermediate characteristics, and the red band is more responsive for deep characteristics. Therefore, the use of narrow band lights is able to cause wavelength-induced changes in visibility and helps to enhance the visibility when a proper light wavelength is selected. Again, NBI will be more time consuming than the conventional endoscopy since an area may have to be imaged repeatedly using different color filters. While chromoendoscopy and NBI have some advantages over conventional endoscopy, such techniques are not applicable to capsule camera system since it is impractical to incorporate a dye spraying device or a switchable color filter device in the capsule.

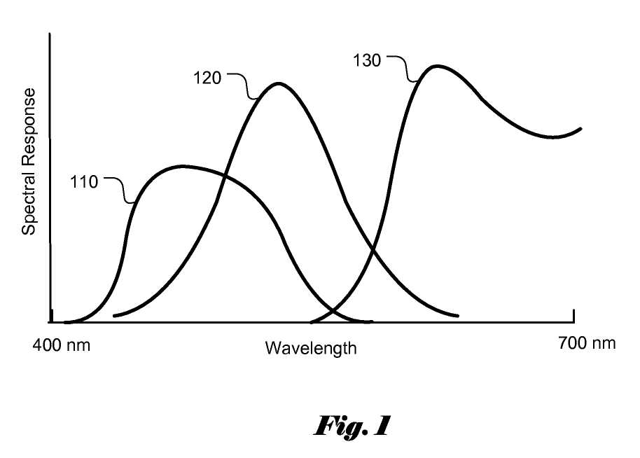

To overcome the drawbacks of chromoendoscopy and NBI, a new method to generate chromoendoscopy images based on conventional endoscopy images using spectral estimation technique has been developed in recent years. The method is termed as Computed Virtual Chromoendoscopy (CVC). FICE (Flexible spectral Imaging Color Enhancement) is an image processing function optionally available with the VP-4400, an endoscope processor distributed by Fujinon Corporation, where FICE is based on the CVC technology. In a typical imaging system, the object to be imaged is illuminated by visible light having wavelength from about 400 to 700 nm. Furthermore, a white light source is often used which consists of light having wavelength covering most of the visible range. The CVC technique can be applied to images captured using a capsule camera since CVC is an image post processing technique that is applied to images already captured. The light reflected from the object is projected through a lens onto an image sensor. To capture color information, an endoscope often uses a filter disk to sequentially illuminate the tissue through RGB filters. A monochrome image sensor is used to capture images corresponding to respective color filters. In a capsule camera, the white light source such as LED is often used to illuminate the mucosa. Since it is impractical to use a color filter disk, the image sensor for a capsule camera usually consists of red (R), green (G) and blue (B) pixels where each color pixel is formed by placing a respective color filter using color filter array (CFA) in front of a monochrome sensor. While the color filters are designated as R, G and B, each color filter has relatively wide spectral response around a nominal wavelength. For example, the blue filter may be peaked at about 470 nm; the green filter may be peaked at about 525 nm; and the red filter may be peaked at 600 nm. Exemplary spectral sensitivities of a color image sensor using RGB CFA is shown in FIG. 1, where exemplary spectral responses for the blue component 110, the green component 120 and the red component 130 are shown.

The object surface being imaged has corresponding spectral reflectance associated with the characteristics of the object surface. The spectral reflectance from the object is then processed by respected color filters and captured by the image sensor to form RGB pixels. The spectral reflectance of an object can be estimated from the captured image by solving a set of equations. The techniques to solve the set of equations are known in the literature, such as Atlas of Spectral Endoscopic Images, Edited by Teruo Kouzu, Department of Endoscopic Diagnostics and Therapeutics, Chiba University Hospital, published in June 2008, and “A Spectral Color Imaging System for Estimating Spectral Reflectance of Paint”, by Vladimir Bochko, Norimichi Tsumura, Yoichi Miyake, in Journal of Imaging Science and Technology, Vol. 51, No. 1, pp. 70-78, published in 2007. The underlying theory behind the spectral estimation is the principal component analysis of spectral reflectance. The outputs of the principal component analysis (PCA) of spectral reflectance are three principal components of spectral reflectance of the object when a color filter having three colors is used. While RGB colors are often used in the color filter, other color filter set having more than three colors may be used. In the FICE system, upon the derivation of the three principal components of spectral reflectance of the object, a spectral image corresponding to a hypothetic color filter can be generated. A spectral color image is formed by using the spectral images to drive the color channels of a display device. RGB color channels are usually used for display devices. However, color channels with more than three channels may also be used for display devices. To create a spectral color image corresponding to a chromoendoscopy image or an image from NBI, respective spectral responses can be applied to the estimated principal components, where the respective spectral responses typically have much narrower bandwidth. The FICE system uses pre-calculated coefficients stored in a look-up table to compute spectral images (I_{λ1}, I_{λ2}, I_{λ3}) at three wavelengths (λ1, λ2, λ3) according to the following 3×3 matrix:

$$[ \begin{matrix}{I}_{λ 1} \\ {I}_{λ 2} \\ {I}_{λ 3}\end{matrix} ] = [ \begin{matrix}{k}_{1 r} & {k}_{1 g} & {k}_{1 b} \\ {k}_{2 r} & {k}_{2 g} & {k}_{2 b} \\ {k}_{3 r} & {k}_{3 g} & {k}_{3 b}\end{matrix} ] [ \begin{matrix}{I}_{R} \\ {I}_{G} \\ {I}_{B}\end{matrix} ] , \qquad ( 1 )$$

where kᵢᵣ, k_{ig} and k_{ib} are the pre-calculated coefficients for deriving the spectral images, i=1, 2 or 3, and I_{R}, I_{G} and I_{B} are the RGB intensities of a captured image.

Accordingly, FICE assigns estimated spectral images to RGB components of a display in real time. FICE assigns a preset pattern number to each pre-defined set of three wavelengths (λ1, λ2, λ3). Furthermore, each component is allowed to have its own gain value. In addition, FICE also allows a user to manually modify the wavelength and/or gain for each component. In various examples illustrated in Atlas of Spectral Endoscopic Images, Edited by Teruo Kouzu, Department of Endoscopic Diagnostics and Therapeutics, Chiba University Hospital, published in June 2008, one spectral pattern may bring out more visibility of an anomaly, such as a lesion, than other spectral patterns. It does not seem to have a single present pattern that always brings out more visibility of anomaly or a problem area. Therefore, it is desirable to develop a system and method that can improve the possibility of selecting a proper pattern to bring out more visibility of anomaly or a problem area without the drawbacks of prolonging viewing time or increasing system complexity.

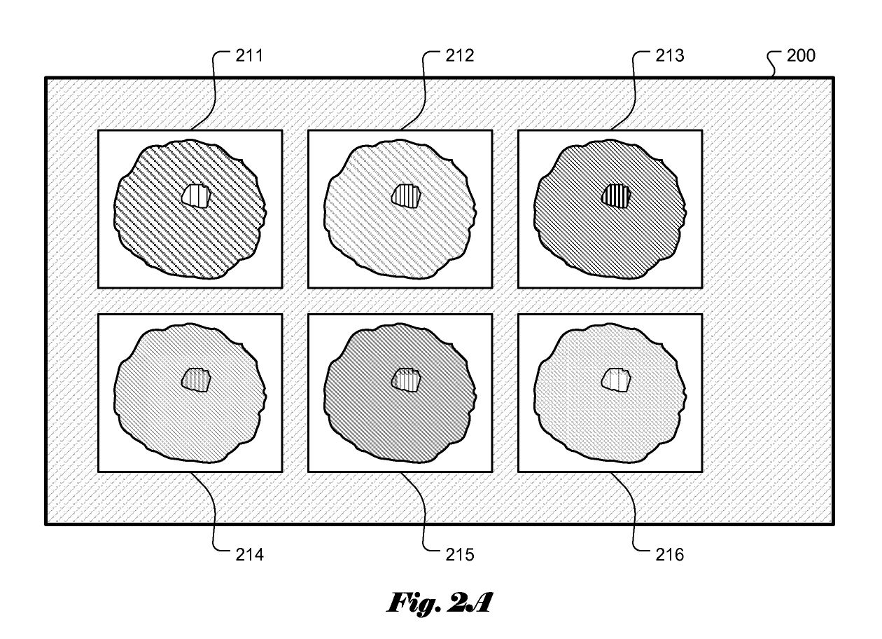

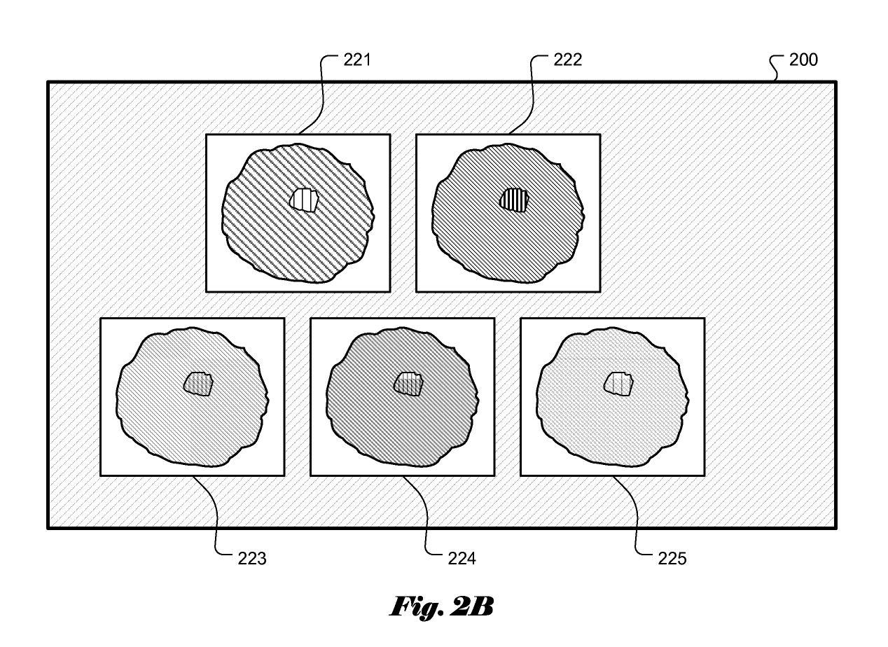

Accordingly, the present invention uses multiple display windows to display multiple CVC sequences concurrently, where each display window corresponds to a series of CVC images processed using one spectral pattern. The spectral pattern refers a set of three spectral responses having nominal wavelengths (λ1, λ2, λ3). The wavelength where the peak response occurs may be designated as a nominal wavelength. For convenience, a spectral pattern may be referred to by the nominal wavelengths. For example, first spectral pattern may be selected to be (R: 525 nm, G: 500 nm, B: 475 nm) and second spectral pattern may be selected to be (R: 550 nm, G: 495 nm, B: 450 nm). The CVC sequence associated with the first spectral pattern can be displayed along with the CVC sequence associated with the second spectral pattern using multiple display windows on one or more screens. More than two display windows may be used. Depending on the image size and the screen size, window configurations such as 2×2, 3×2, 4×2, 3×3, 4×3 or 4×4 windows may be used. Display window M×N refers to multiple display windows configured as M windows per row and N windows per column. An example of 3×2 window configuration is shown in FIG. 2A, where six display windows 211-216 are displayed on a single screen 200. It may be desired to use one window to show the original sequence and other windows for CVC sequences. A benefit of using multiple windows to concurrently display CVC sequences corresponding to different spectral patterns is apparent. Instead of viewing image sequences corresponding to CVC images with different spectral patterns one by one, the present invention allows all sequences viewed at once. When any visible anomaly stands out in any of these windows, the anomaly will be spotted by a diagnostician or a trained viewer. While one display device is used, multiple devices may be used to display the multiple CVC sequences concurrently. For example, in the case of 3×2 windows mentioned above, 2×2 windows may be displayed on one display device while the remaining 2×1 windows may be displayed on the other device. The device for the 2×1 windows may also be used to display other information such graphic or text-based user interface. The arrangements of multiple windows mentioned above always have the same number on a row and the same number on a column. Nevertheless, the window configurations mentioned above should not be construed as limitation to the present invention. Other window configurations may also be used to practice the present invention. For example, the multiple windows may be configured with two windows 221-222 in the first row and three windows 223-225 in the second row as shown in FIG. 2B.

The CVC sequences derived from an original image sequence may be generated and stored in a storage device such as a computer hard drive. The pre-processed CVC sequence corresponding to each spectral pattern may be retrieved from the storage device and displayed in a display window. Alternatively, the CVC image sequences may also be generated in real time where the system is capable of computing the set of CVC images corresponding to the set of spectral patterns for each original image within an image period. Computing the set of CVC images may be based on a single computational resource fast enough to support the required computations within a given time interval. Alternatively, computing the set of CVC images may be based on multiple computational resources to support the required computations within a given time interval. When multiple computation resources are used, the required computational speed of each of the computational resources can be lowered. Real-time implementation of image processing is known in the art and the detailed implementation will not be repeated herein. One benefit of generating CVC sequences in real-time has an advantage to allow a user to modify parameters of the spectral patterns on the flight.

Each tissue type and each anomaly may have its own surface characteristic and may need certain spectral patterns to bring out or enhance the visibility of potential anomaly. A set of spectral patterns may be pre-designed according to some parameters such as the type of tissue being imaged, the light source and the color image sensor being used. The possible spectral patterns may be very large due to the multitude of parameters involved. As mentioned before, a set of three spectral images (I_{λ1}, I_{λ2}, I_{λ3}) is computed with three spectral responses with nominal wavelengths (λ1, λ2, λ3) in order to generate a CVC image. In addition, the gain values (α1, α2, α3) for the three respective spectral components may also be adjusted. When a spectral image has low intensity, a higher gain for this component may help to improve the visibility of anomaly if the anomaly is more responsive for this wavelength. However, a higher gain value will also boost the noise level at the same time. Therefore, the gain value has to be properly chosen as a compromise between the visibility enhancement and image noise. In the FICE system, the spectral response of the color filter corresponding to each spectral image has a bandwidth of 5 nm. However, the choice of 5 nm bandwidth may not be always the best for all types of tissues. Accordingly, in one embodiment according to the present invention, the three spectral responses to generate the spectral images are allowed to have varying bandwidths. The bandwidths of the three spectral responses can be changed individually. The total number of combinations of the three spectral filters may be very large. However, the determination of the set of pre-designed spectral patterns is only performed once for a tissue being imaged, a light source and a color image sensor being used. In practice, the number of pre-designed spectral patterns may be larger than the number of windows to be used. The extra spectral patterns may be used as alternative patterns for a user to replace one or more spectral patterns being used for multiple window display. Furthermore, multiple sets of spectral patterns may be provided to allow a user to select. The selection may be according to user's preference or other factors. The selection may also be according to certain characteristic of the tissue that may be more responsive to certain spectral patterns. For example, one anomaly may be more visible in a first set of spectral patterns and another anomaly may be more visible in a second set of spectral patterns.

In order to provide convenient user interface, one embodiment according to the present invention will display a set of CVC sequences corresponding to a set of spectral patterns selected by a user according to user indication. A default set of spectral patterns is used if the user indication is not available. There are various means to allow a user to provide user indication to select a set of spectral patterns. For example, a pull-down menu as used in a typical personal computer environment may be used to display a list of available spectral pattern sets. The user may move and position a cursor over the menu using a pointing device such as a computer mouse device. Usually, there is one or more buttons on the pointing device to allow the user to signal user's selection. For example, when the cursor is over a menu bar or a menu icon displayed on the screen, a button on the pointing device may be pushed by the user to signal user's indication to select the menu. Accordingly, a list of available choices associated with the menu may be displayed. For example, a text based menu may display a list, “Set A, Set B, Set C” for a user to select one out of three pre-defined sets of spectral patterns as shown in FIG. 3. The menu “Spectral Pattern Set” 300 may be displayed on the display device along with the CVC sequences. When cursor 340 is pointed to the menu and a button on the pointing device is pushed, a pop-up selection among a set of set names may be displayed, such as “Set A” 310, “Set B” 320 and “Set C” 330. The cursor can be used to make the selection. When the cursor moves over a selection, the selection can be highlighted to indicate the current cursor selection. For example, when cursor 340 is over “Set B” 320 and “Set B” 320 is highlighted with different background color as shown in FIG. 3. The set of spectral patterns being used may be highlighted so that the user can distinguish the current set from other sets. For example, if “Set A” 310 is the current set of spectral patterns being used and a thick box 350 can be used to indicate the current set as shown in FIG. 3.

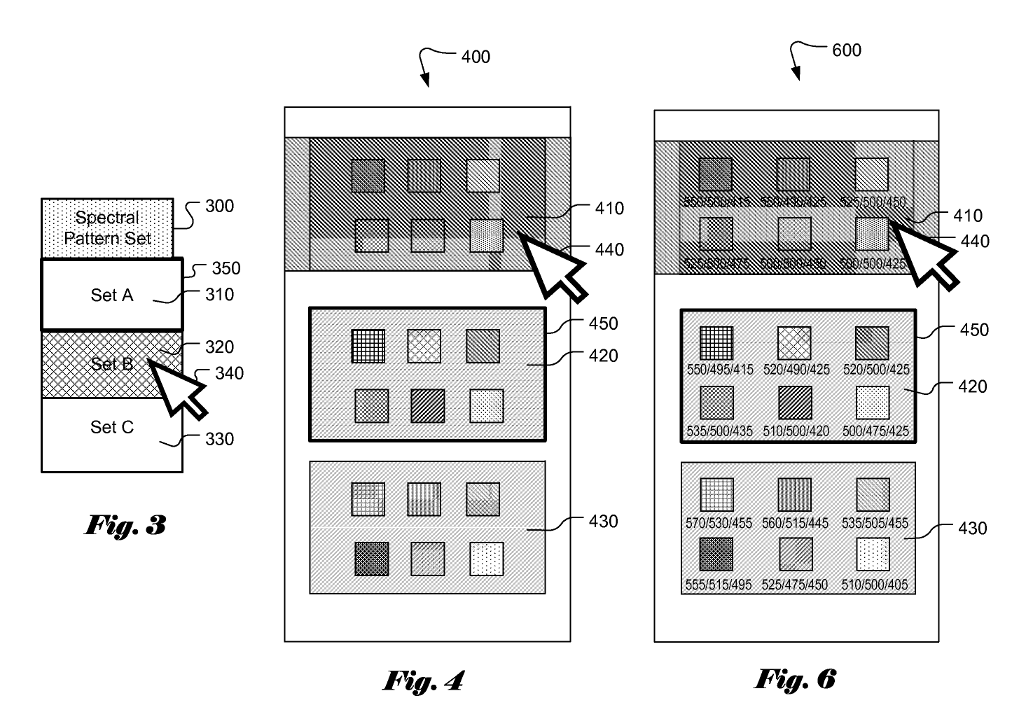

While a text based menu is easy to implement, a graphic based menu may also be used. When a graphic based menu is used, a graphic representation of the set of spectral patterns can be displayed where an icon for each spectral pattern may be used. The arrangement of the graphic representation of the set of spectral patterns may be corresponding to the set of CVC sequences associated with the set of spectral patterns as shown in FIG. 4, where six color patches correspond to the six CVC sequences in the six display windows of FIG. 2A. The icon may be designed according to characteristics of the spectral pattern. Each spectral pattern in a set may be represented by a color patch related to the spectral responses of the three components of the spectral pattern. For example, the RGB components of the color patch for each spectral pattern may be formed by deriving the RGB components associated with the set of wavelengths (λ1, λ2, λ3)of the spectral pattern. The method of deriving the RGB components is similar to the method that FICE assigns estimated spectral images to RGB components by using 3×3 matrix conversion for the set of wavelengths (λ1, λ2, λ3). However, instead of using the RGB components of the imaged object, the assignment for color patch uses the RGB components corresponding to white color. Accordingly, the color for each spectral pattern having a set of wavelengths (λ1, λ2, λ3)can be derived. Alternatively, a representative color can be assigned to each spectral pattern, where the selected color may or may not be related to the characteristics of the spectral pattern. FIG. 4 illustrates an exemplary graphic user interface 400 where three color palettes 410, 420 and 430 representing the three sets of spectral patterns available. Cursor 440 can be used to make the selection. When the cursor moves over a selection, the selection can be highlighted to indicate the current cursor selection. For example, when cursor 440 is over color palette 410 and color palette 410 is highlighted with different background color as shown in FIG. 4. The set of spectral patterns being used may be highlighted so that the user can distinguish the current set from other sets. For example, if color palette 420 is the current set of spectral patterns being used and a thick box 450 is used to indicate the current set as shown in FIG. 4.

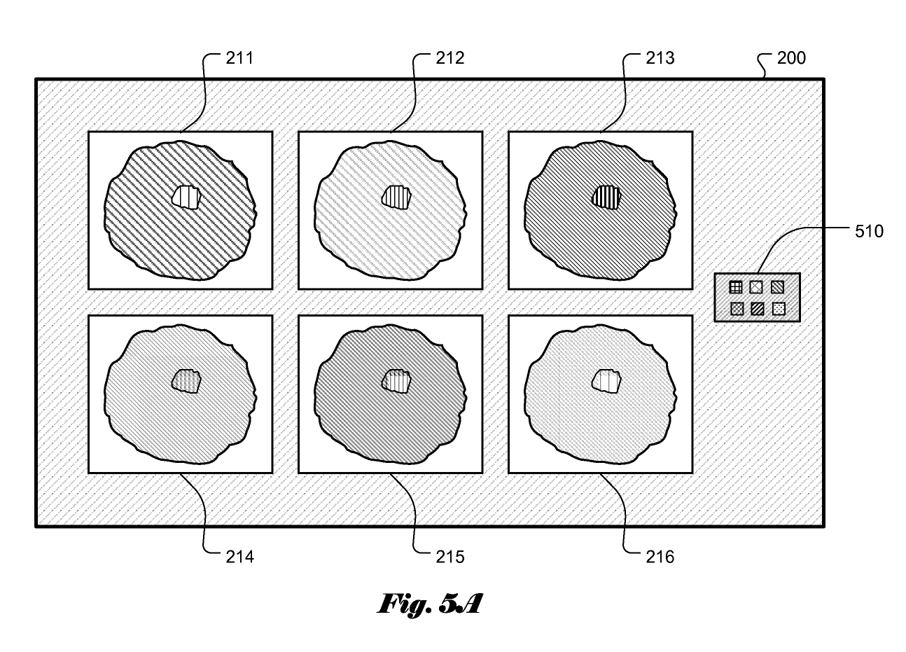

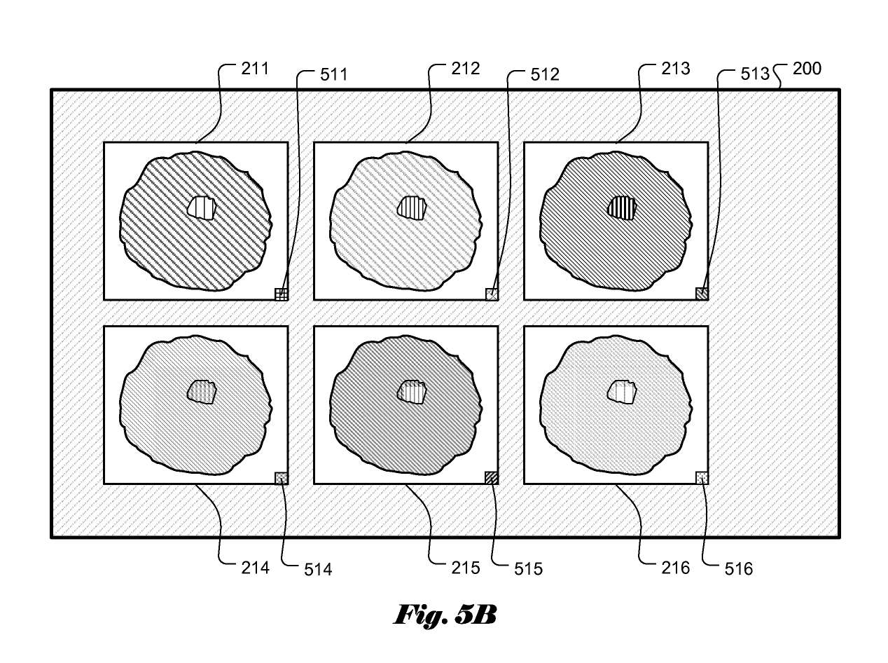

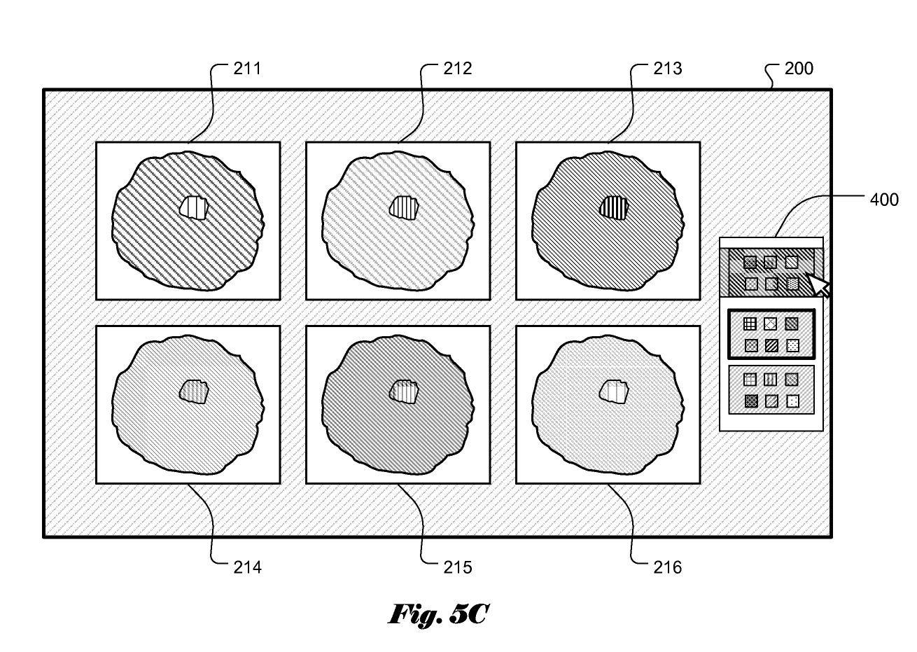

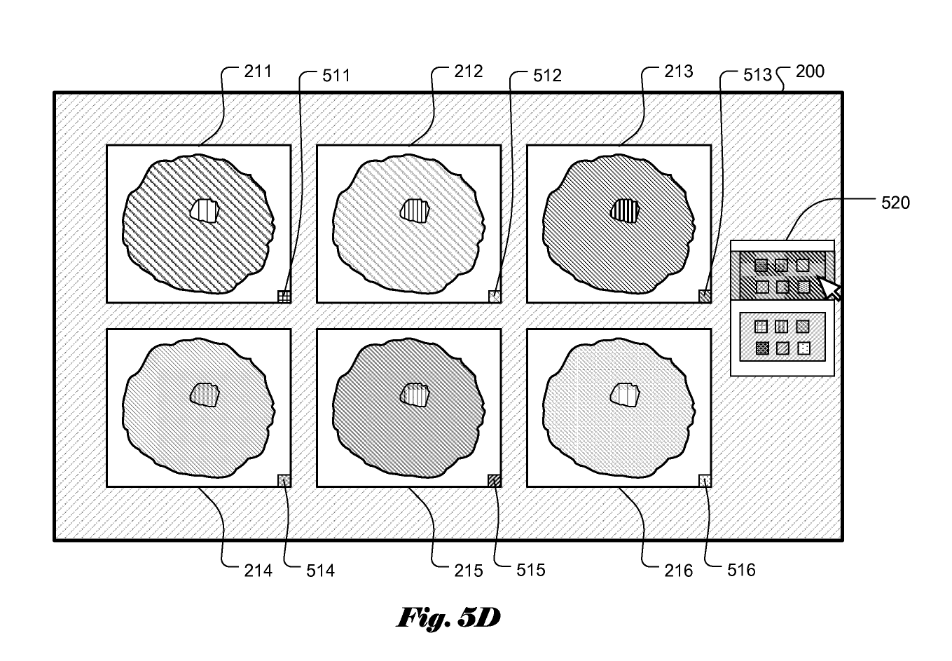

In one embodiment of the present invention, the graphic representation of the set of spectral patterns is always displayed on the screen as shown in FIG. 5A and FIG. 5B, where the graphic representation is in the form of a color palette 510 in FIG. 5A and where the graphic representation is in the form of individual color patches 511-516 with respective display windows 211-216 in FIG. 5B. In another embodiment of the present invention, the graphic user interface 400 is displayed next to the six display windows as shown in FIG. 5C. FIG. 5D illustrates an alternative graphic user interface 520 where graphic user interface 520 comprises the set of available spectral patterns. In this case, a person viewing the CVC sequences is always aware of the color characteristic of the set of spectral patterns being used and other choices available. Alternatively, the graphic representation of the set of spectral patterns can be hided. A user may provide indication to un-hide the graphic representation of the set of spectral patterns and to view and/or change the set of spectral patterns. For example, a typical computer mouse or pointing device may have two buttons and one of the buttons may be used to indicate the user's desire to unhide the graphic representation. The capability to unhide the graphic representation may be enabled when one of the buttons on the pointing device is pressed. The graphic representation 600 of the set of spectral patterns may also include text information. For example, text may be on or next to the color patch associated with a spectral pattern where the text may indicate wavelengths of the spectral patterns as shown in FIG. 6.

While use of sets of pre-determined spectral patterns offers convenience for users to examine multiple CVC sequences concurrently, sometimes a user may like to modify one or more of the set of spectral patterns being selected. For example, the user may like to modify one or more parameters including the wavelength, the bandwidth and the gain associated with the spectral pattern. It will be beneficial for a user to be able to visualize the effect of parameter change substantially instantly. The CVC image in a corresponding window where one or more parameters are being modified can provide useful feedback to user regarding the parameter change. For example, a user may be able to determine whether the current parameter change improves the visibility of certain characteristics or features. A text based approach may be used to offer the capability. For example, an input box may be provided to allow a user to enter desired wavelength or wavelengths. Alternatively, a list of allowed wavelengths may be displayed to allow a user to select one from the list. In another embodiment according to the present invention, a graphic based approach is used to allow a user to modify the spectral pattern. The graphic based approach may provide graphic user interface to allow a user to enter modification. For example, an indication can be displayed on screen where the indication may be moved using a pointing device. The position of the indicator may be associated with the wavelength selected. For example, the indicator may be dragged over a range corresponding to 500 nm to 700 nm for R component, 415 nm to 500 nm for G component, and 400 nm to 495 nm for B component. While the allowable ranges for the three spectral components may overlap, however the wavelength of the selected R component is at least as large as the wavelength of the selected G component and the wavelength of the selected G component is at least as large as the wavelength of the selected B component for a properly designed set of spectral patterns. Therefore, an embodiment according to the present invention provides graphic user interface for adjusting RGB wavelengths where neighboring indicators interact with each other so that the wavelength of the selected R component will be always at least as large as the wavelength of the selected G component and the wavelength of the selected G component will be always at least as large as the wavelength of the selected B component.

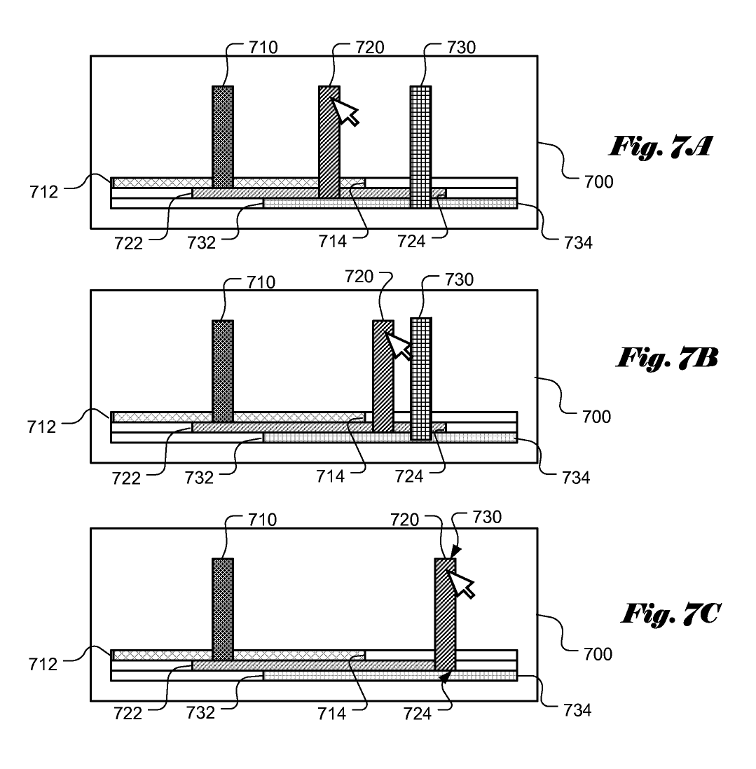

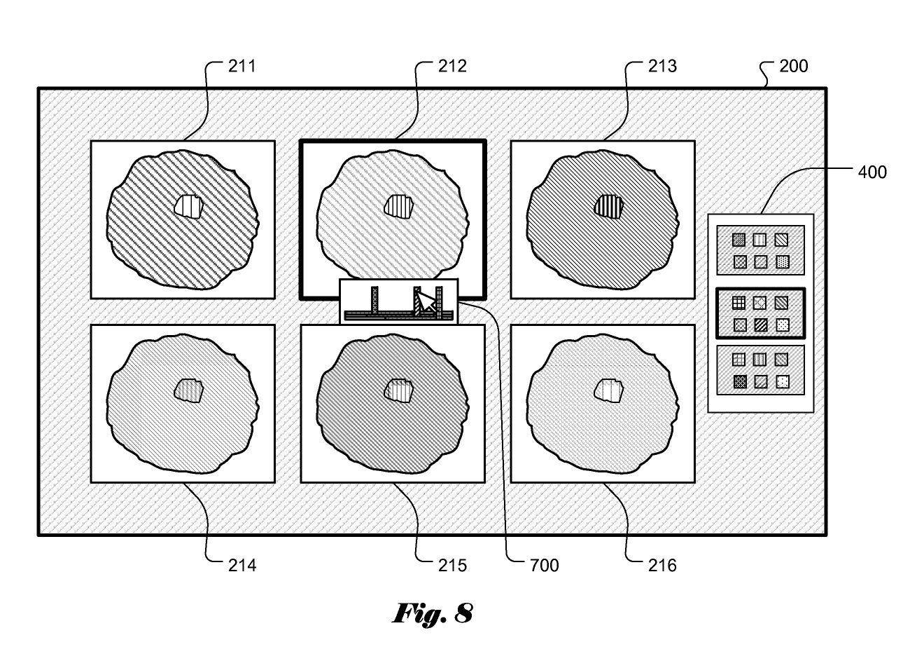

An exemplary graphic user interface design incorporating an embodiment of the present invention is shown in FIGS. 7A-C. The horizontal scale corresponds to the range of wavelength. For example, the range from 400 nm to 700 nm may be used. Indicators 710, 720 and 730 correspond to the center wavelengths for the blue, green and red components respectively. FIG. 7A illustrates graphic user interface 700 at initial setting. The initial setting may correspond to the wavelengths of the spectral pattern to be modified. Alternatively, the initial setting may be assigned to the centers of respective ranges. FIG. 7B illustrates the scenario that the wavelength for the green component is increased by dragging green indicator 720 to the right. FIG. 7C illustrates the scenario that green indicator 720 is further moved beyond original red indicator 730 position. FIG. 7C illustrates the case that red indicator 730 is pushed to the right at the same location as indicator 720 to ensure the red wavelength to be no smaller than the green wavelength. Alternatively, green indicator 720 may be stopped at the old red indicator 730 position so that green indicator 720 will not go beyond the original red indicator 730 position.

FIG. 8 illustrates an example of using graphic user interface to modify the spectral pattern of a selected display window. Modification of spectral pattern for a selected window may be activated by placing the cursor on the selected window and pushing a button on the pointing device. For example, window 212 is selected as highlighted by a thick box. The graphic user interface 700 can be popped up when the modification is activated. Other means may also be used to enable spectral pattern modification. The gain of each spectral response may also be modified using graphic user interface. For example, a cursor may be placed on the top edge of a respective indicator and the gain adjustment can be enabled by holding down a button on the mouse or pointing device. When the gain adjustment is enabled, movement of the mouse or the pointing device can be used to cause gain adjustment. In addition, the bandwidth of each spectral response may also be modified using graphic user interface. For example, a cursor may be placed on the left or right edge of a respective indicator and the bandwidth adjustment can be enabled by holding down a button on the mouse or pointing device.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for presenting in-vivo image data, the method comprising:
receiving in-vivo image data from an in-vivo imaging device;
receiving a plurality of computed spectral sequences, wherein each of the plurality of computed spectral sequences is generated based on the in-vivo image data according to a spectral pattern; and
displaying the plurality of computed spectral sequences concurrently on one or more display devices.

2. The method of claim 1, further comprising displaying the in-vivo image data with the plurality of computed spectral sequences concurrently on said one or more display devices.

3. The method of claim 1, wherein the spectral pattern comprises three spectral responses corresponding to three color filters.

4. The method of claim 3, wherein each computed spectral color image of said each computed spectral sequence consists of three spectral images generated from each image of the in-vivo image data according to the three spectral responses.

5. The method of claim 1, further comprising displaying graphic representation corresponding to the spectral pattern associated with said each computed spectral sequence.

6. The method of claim 5, wherein the graphic representation is related to a color derived from the spectral pattern.

7. The method of claim 1, further comprising providing user interface to select a set of spectral patterns from a plurality of sets of spectral patterns, wherein the set of spectral patterns is associated with the plurality of computed spectral sequences displayed on said one or more display devices.

8. The method of claim 7, wherein the user interface is based on graphic user interface having a plurality of color palettes, wherein each of the plurality of color palettes corresponds to one of the plurality of sets of spectral patterns, and wherein each color in one of the plurality of color palettes corresponds to one of the set of spectral patterns.

9. The method of claim 7, wherein the user interface is based on text user interface having a plurality of set names, wherein each of the plurality of set names corresponds to one of the plurality of sets of spectral patterns.

10. The method of claim 1, further comprising providing user interface to modify one or more parameters of the spectral pattern associated with a selected spectral sequence of the plurality of computed spectral sequences displayed on said one or more display devices.

11. The method of claim 10, wherein said one or more parameters of the spectral pattern are selected from a group consisting of wavelength, bandwidth and gain associated with each of three spectral responses corresponding to three color filters.

12. The method of claim 10, wherein the spectral pattern comprises three spectral responses corresponding to three color filters; wherein a first wavelength, a second wavelength and a third wavelength are associated with the three spectral responses respectively; wherein the user interface is based on graphic user interface having a first indicator to adjust the first wavelength, a second indicator o adjust the second wavelength and a third indicator to adjust the third wavelength; wherein the first indicator is interacted with the second indicator to prevent the first wavelength to be larger than the second wavelength; and wherein the second indicator is interacted with the third indicator to prevent the second wavelength to be larger than the third wavelength.

13. A system for presentation of in-vivo image data, the system comprising:
an interface unit to receive in-vivo image data from an in-vivo imaging device;
a processor to generate a plurality of computed spectral sequences based on the in-vivo image data, wherein each computed spectral sequence is derived from the in-vivo image data according to a spectral pattern; and
a display unit to display the plurality of computed spectral sequences concurrently.

14. The system of claim 13, wherein the display unit also displays the in-vivo image data with the plurality of computed spectral sequences concurrently.

15. The system of claim 13, wherein the spectral pattern comprises three spectral responses corresponding to three color filters.

16. The system of claim 15, wherein each computed spectral color image of said each computed spectral sequence consists of three spectral images generated from each image of the in-vivo image data according to the three spectral responses.

17. The system of claim 13, wherein the processor further provides graphic representation corresponding to the spectral pattern associated with said each computed spectral sequence to display on the display unit.

18. The system of claim 17, wherein the graphic representation is related to a color derived from the spectral pattern.

19. The system of claim 13, wherein the processor further provides user interface to select a set of spectral patterns from a plurality of sets of spectral patterns, wherein the set of spectral patterns is associated with the plurality of computed spectral sequences displayed on the display unit.

20. The system of claim 19, wherein the user interface is based on graphic user interface having a plurality of color palettes, wherein each of the plurality of color palettes corresponds to one of the plurality of sets of spectral patterns, and wherein each color in one of the plurality of color palettes corresponds to one of the set of spectral patterns.

21. The system of claim 13, further comprising providing user interface to modify one or more parameters of the spectral pattern associated with a selected spectral sequence of the plurality of computed spectral sequences displayed on the display unit.

22. The system of claim 21, wherein said one or more parameters of the spectral pattern are selected from a group consisting of wavelength, bandwidth and gain associated with each of three spectral responses corresponding to three color filters.

23. The system of claim 21, wherein the spectral pattern comprises three spectral responses corresponding to three color filters; wherein a first wavelength, a second wavelength and a third wavelength are associated with the three spectral responses respectively; wherein the user interface is based on graphic user interface having a first indicator to adjust the first wavelength, a second indicator o adjust the second wavelength and a third indicator to adjust the third wavelength; wherein the first indicator is interacted with the second indicator to prevent the first wavelength to be larger than the second wavelength; and wherein the second indicator is interacted with the third indicator to prevent the second wavelength to be larger than the third wavelength.
